(19) United States
(12) Patent Application Publication
(10) Pub. No.: US 2011/0068669 A1
(43) Pub. Date: Mar. 24, 2011

(54) FURNITURE DRIVE

(76) Inventor: Helmut HOLLENSTEIN, Lustenau (AT)

(21) Appl. No.: 12/956,011

(22) Filed: Nov. 30, 2010

Related U.S. Application Data
(63) Continuation of application No. PCT/AT2009/000231, filed on Jun. 10, 2009.

(30) Foreign Application Priority Data
Jul. 18, 2008 (AT) A 1117/2008

(51) Int. Cl. A47B 95/00; H02K 7/04

(52) U.S. Cl. 312/319.1; 310/66

(57) ABSTRACT

Furniture drive for moving a furniture part which is mounted in a vertically adjustable manner, having a drive apparatus, which has an electric motor, for moving the movable furniture part, and having a compensation device which exerts a force which is opposite to the weight force on the movable furniture part, wherein a measuring device is provided for detecting the weight of the movable furniture part, and therefore the force exerted by the compensation device on the movable furniture part can be variably adjusted as a function of the measured weight of the movable furniture part by an adjusting device which has a further electric motor and can be actuated by the measuring device.

The present invention concerns a furniture drive for moving a furniture part which is mounted displaceably in respect of height, comprising a drive device having an electric motor for moving the movable furniture part and a compensation device which exerts on the movable furniture part a force opposite to the force due to weight.

In addition the invention concerns an article of furniture having a furniture drive of the kind to be described.

With such furniture drives a frequent problem is that of ensuring a harmonic pattern of movements even in different loaded conditions of the movable furniture part. More specifically if the movable furniture part is subject to differing loadings due to items accommodated therein then the drive device must also apply forces of differing magnitude to the movable furniture part. That however requires an electric drive which ensures a dynamic movement of the movable furniture part even at maximum loading. To keep down the power dimensions of the drive device there is provided a compensation device which exerts a force opposite to the force due to weight, on the movable furniture part, so that the electric drive can be at least partially relieved of load thereby.

The object of the present invention is to propose a furniture drive of the general kind referred to in the opening part of this specification, which even with different loading conditions of the movable furniture part, permits a uniform regular pattern of movement.

In an advantageous configuration according to the invention that is achieved in that there is provided a measuring device for detecting the weight of the movable furniture part so that the force exerted by the compensation device on the movable furniture part is variably adjustable in dependence on the measured weight of the movable furniture part by an adjusting device which has a further electric motor and which is actuable by the measuring device.

In that way a force opposite to the force due to weight is applied to the movable furniture part, and that force is actively variable depending on the respective loading condition of the movable furniture part. In that way the drive device can be supported with different compensation forces so that the power dimensions of the drive device can be relatively small. By virtue of the compensation device which is variable in terms of its force the drive device only has to apply comparatively low forces for raising and lowering the movable furniture part.

The force of the compensation device, that is to be applied to the movable furniture part, is therefore adjustable in accordance with the detected weight of the movable furniture part, in variable fashion. Basically it is possible to use any device which is provided for determining the weight of the movable furniture part, as the measuring device. In that respect mention may be made in particular of force pickups or force sensors which can detect both pressure and also traction forces. It is equally possible to use measuring devices for detecting rotary moments. The movement applied to the measuring device can be effected both in rotational mode and/or in sliding mode by pressure or traction loading.

In accordance with a preferred embodiment it can be provided that the measuring device for detecting the weight of the movable furniture part includes at least one force measuring cell which is known from the state of the art and by which a force signal corresponding to the weight of the movable furniture part can be fed to the compensation device. Such force measuring cells are commercially available and permit long service lives which are practically maintenance-free. Mounting forces, rotary moments or contact support forces can be reliably, quickly and exactly detected by means of such force measuring cells.

In accordance with the invention it is therefore provided that the compensation device includes at least one adjusting device having an electric motor, wherein the adjustment device is actuable by the measuring device. In principle the electric motor of the adjustment device can apply the forces required for weight compensation directly to the movable furniture part. In a preferred embodiment of the invention however it may be desirable if the compensation device has a spring device, wherein the biasing of the spring device is variably adjustable by a displacement—preferably by electric motor means. In this connection it may also be desirable if the spring device has a spring mounting, wherein the position of the spring mounting is adjustable by the adjustment device so that the biasing of the spring device can also be varied in that way.

In other words the electric motor of the compensation device can be in the form of an adjusting motor for the spring device, wherein the electric motor provides for different biasing of the spring device in dependence on the detected weight. The spring device of the compensation device can be formed both by mechanical spring elements and also by at least one gas pressure spring which are operative on the movable furniture part by way of a lever arrangement. The electric motor which influences the compensation device in terms of force can adjust the effective lever arm length of the lever arrangement or adjust the position of the spring device, in positionally variable relationship.

In advantageous development of the invention it can be provided that the compensation device has an actuating arm for acting on the movable furniture part, wherein a transmission mechanism converts a movement of the spring device into a pivotal movement of the actuating arm. For that purpose the transmission mechanism can have a lever mechanism and/or a rotatable control cam with an adjusting contour. Desirably in this connection it is possible to use all actuating mechanisms which are known in the state of the art and which are provided for moving upwardly movable furniture flaps. WO 2006/005086 A1 to the present applicant is to be mentioned as an example of such an actuating mechanism.

The actual drive device can act on the movable furniture part by way of a transmission mechanism, wherein the transmission mechanism can have at least one cable line and/or toothed racks with pinions and/or a toothed belt drive. In principle the person skilled in the relevant art can take all precautions and measures known in the state of the art for embodying the transmission mechanism, whether by means of a spindle drive, by means of a hydraulic drive or a pneumatic drive, and so forth.

In addition it may be desirable if the furniture drive has at least one position measuring device which produces a position signal which is characteristic of the opening condition of the movable furniture part and which can be fed to a regulating device. The position signal which is made available in that way can serve for calculation of the instantaneous actual position and/or the instantaneous actual speed and/or the instantaneous actual value of the acceleration or deceleration of the movable furniture part as a function of the measured position.

The article of furniture according to the invention is characterized by at least one furniture drive of the kind in question.

Further details and advantages of the invention are described with reference to the specific description hereinafter. In the drawing:

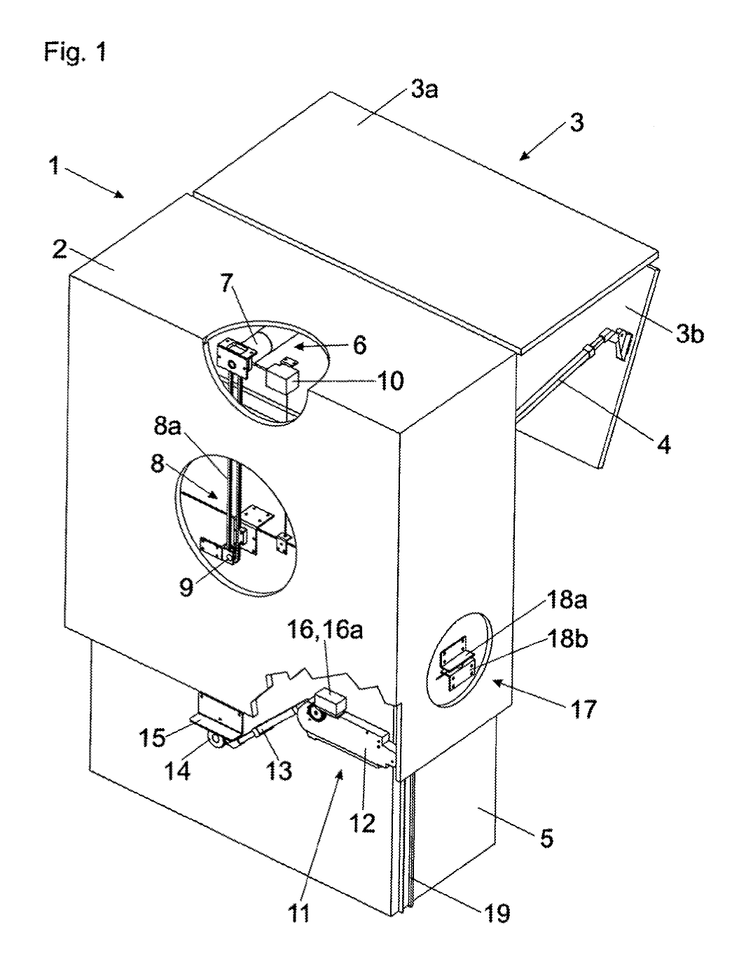

FIG. 1 is a partly broken-away perspective view from the rear of an article of furniture according to the invention,

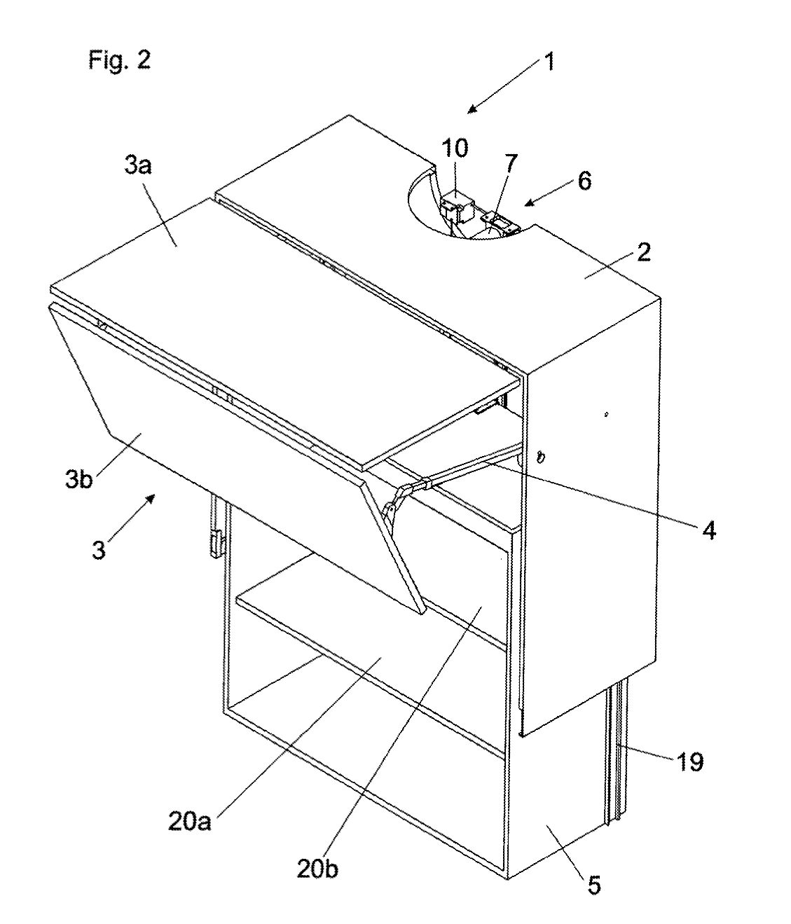

FIG. 2 is a perspective view from the front of the FIG. 1 article of furniture,

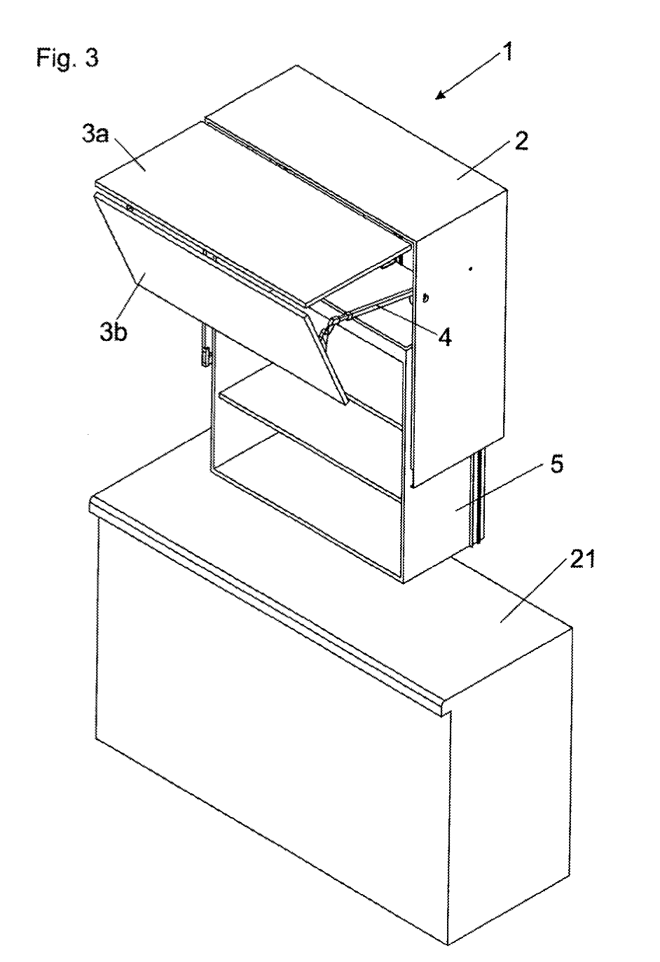

FIG. 3 shows a typical installation position of the furniture with the furniture part lowered,

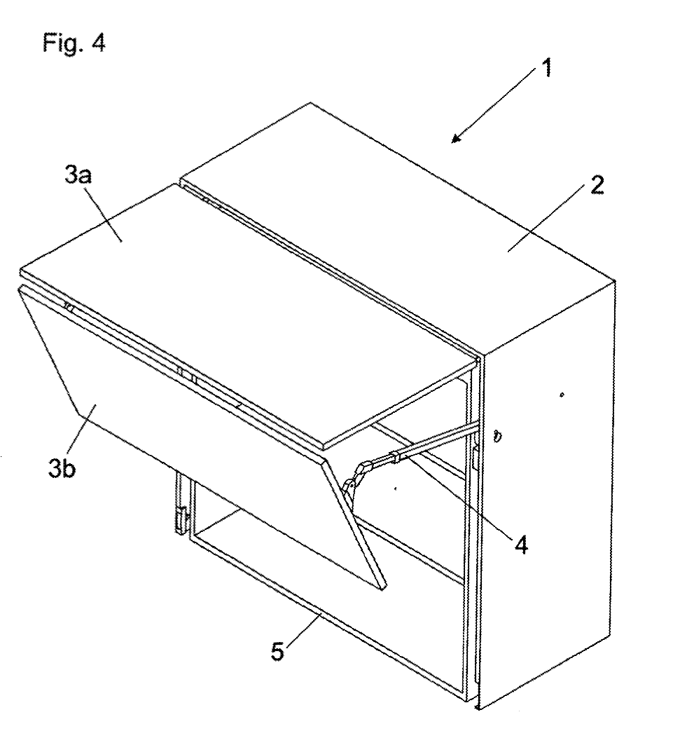

FIG. 4 shows the article of furniture with the furniture part retracted,

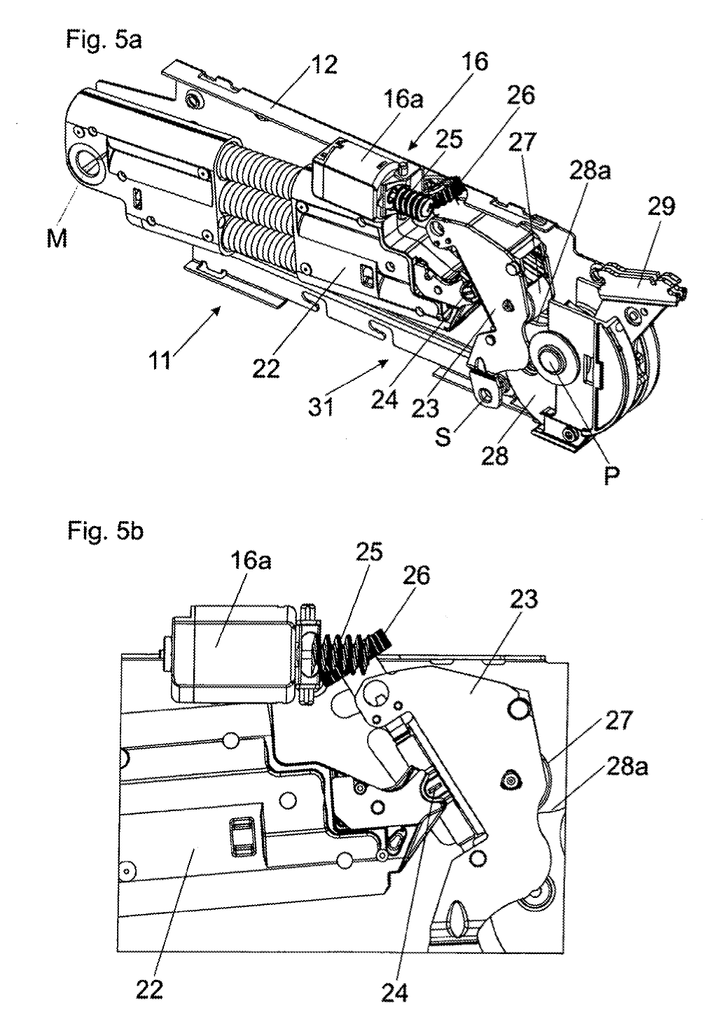

FIGS. 5a, 5b show a possible embodiment of a compensation device as a perspective view and a part of a side view in relation thereto,

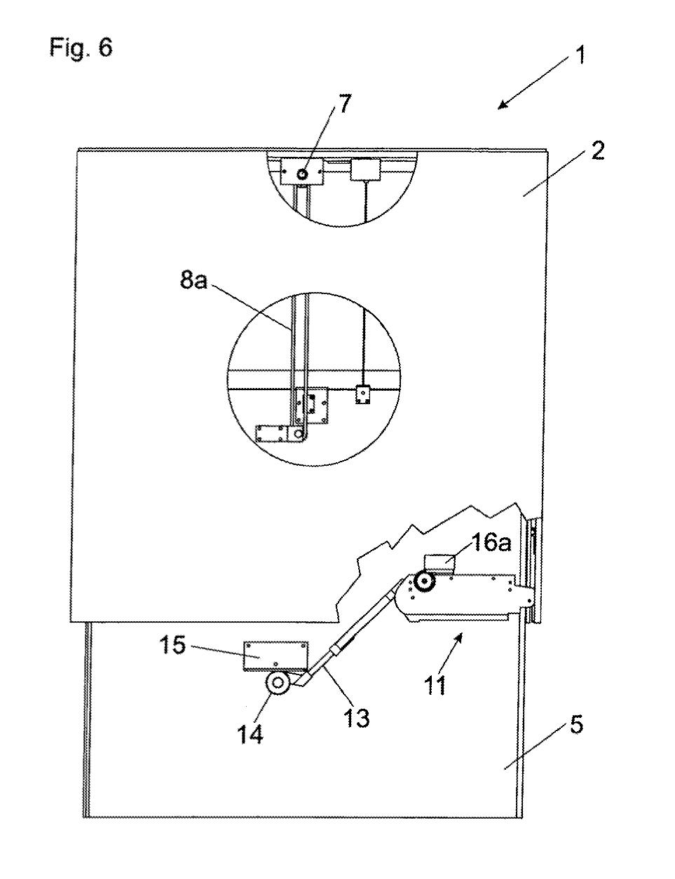

FIG. 6 shows a partly broken-away view of the article of furniture from the rear, and

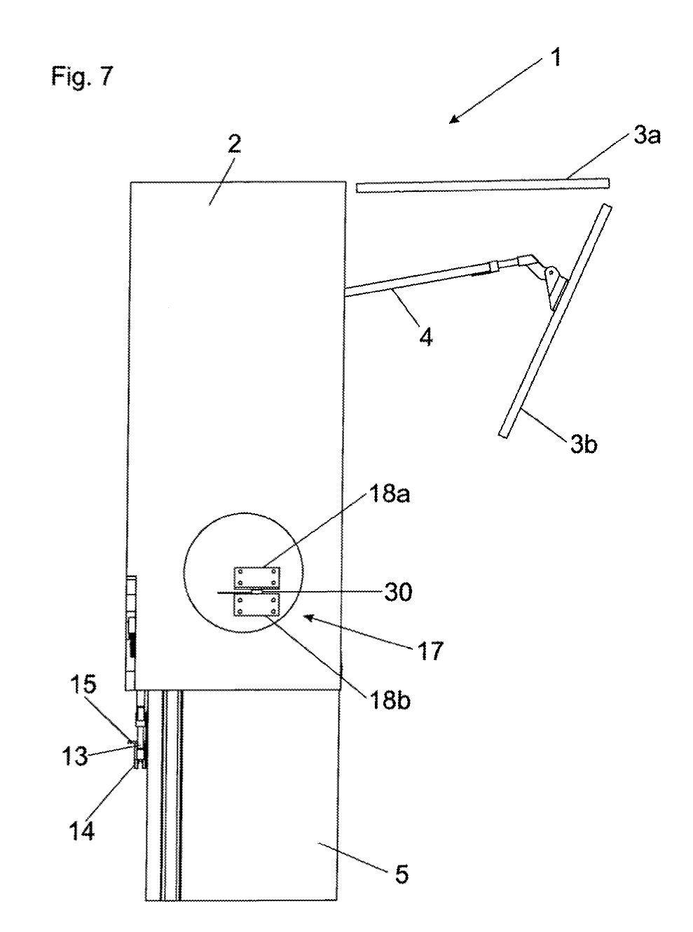

FIG. 7 shows a partly broken-away side view of the article of furniture.

FIG. 1 shows a perspective view from the rear of a possible embodiment of an article of furniture 1 according to the invention, the article of furniture 1 being shown as a partly broken-away view in order better to display the units involved. The article of furniture 1 has a furniture carcass 2 in cabinet form, the cabinet compartment of which can be closed by an upwardly pivotable furniture flap 3. The furniture flap 3 is in the form of an upwardly folding flap with two flap portions 3a and 3b which can be folded together, wherein the upper flap portion 3a is pivotable about a horizontal axis relative to the furniture carcass 2 and the lower flap portion 3b is pivotable about a second horizontal axis relative to the upper flap portion 3a. To move the furniture flap 3 there is provided at least one pivotable actuating arm 4 which is acted upon by a spring device (not shown) to provide for weight compensation of the furniture flap 3. However what is of substantial significance is the furniture part 5 which is displaceable in respect of height and which in the illustrated embodiment is in the form of a cabinet-form carcass portion arranged at least region-wise within the stationary furniture carcass 2. In the illustrated Figure the furniture part 5 is adapted to vertically displaceable relative to the furniture carcass 2 along a linear path of movement so that the furniture part 5 which can be moved downwardly can be loaded or unloaded with articles to be accommodated therein, in the lowered position, whereupon the movable furniture part 5 can be moved back into the raised parking position again. To move the downwardly movable furniture part 5 there is provided a drive device 6 having at least one electric motor 7 which acts on the direction-changing roller 9 mounted on the downwardly movable furniture part 5, by way of a transmission mechanism 8 (preferably a toothed belt 8a). In addition there is provided a diagrammatically illustrated position measuring device 10 for the downwardly movable furniture part 5, said device 10 can include for example a limit switch for detecting a limit position of the downwardly movable furniture part 5. It is possible to see a compensation device 11 which is secured to the furniture carcass 2 and which exerts on the downwardly movable furniture part 5 a force which is in opposite relationship to the force due to weight. In other words the downwardly movable furniture part 5 is urged upwardly by the compensation device 11 to relieve the load on the drive device 6. The compensation device 11 includes a housing 12 in which there is arranged a spring device (not shown in greater detail here) for at least partial compensation of the weight of the downwardly movable furniture part 5. The compensation device 11 further includes an adjusting arm 13 which is mounted to the pivotable housing 12 and which can be acted upon by the spring device arranged in the housing 12. Mounted at the end of the adjusting arm 13 is a roller 14 which can run on a fitment member 15 associated with the downwardly movable furniture part 5. The compensation device 11 further includes an adjustment device 16 having an electric motor 16a, wherein the biasing of the spring device in the housing 12 can be variably adjusted by that adjustment device 16. The adjustment device 16 is now actuable by a measuring device 17 for detecting the weight of the downwardly movable furniture part 5 so that the spring biasing of the compensation device 11 can be automatically adjusted in accordance with the detected weight of the movable furniture part 5. The measuring device 17 includes a mounting member 18a associated with the downwardly movable furniture part 5 and a mounting member 18b associated with the furniture carcass 2. A commercially available force measuring cell is operative between the mounting members 18a and 18b so that the contact force of the movable mounting member 18a (that is to say the weight of the downwardly movable furniture part 5) on the stationary mounting member 18b can be detected.

It should be noted that in the illustrated embodiment for reasons of simplicity measurement of the force due to weight is effected in the lowermost limit position of the downwardly movable furniture part 5. In that way a corresponding control signal is fed to the compensation device 11, for adjusting the compensation force. In a preferred development of the invention the weight of the downwardly movable furniture part 5 is continuously detected whereby a continuous control signal can be fed to the electric motor 16a of the adjustment device 16 for dynamic adjustment of the compensation force.

Provided for linear guidance of the downwardly movable furniture part 5 relative to the furniture carcass 2 are rails 19 mounted at both sides of the downwardly movable furniture part 5. It is to be noted that the furniture part 5 is not only vertically movable relative to the furniture carcass 2 but—in a possible variant—can also be lowered into a pivoted position of being moved further downwardly.

FIG. 2 shows a perspective view from the front of the article of furniture 1 of FIG. 1. It is possible to see therein the drive device 6 having the electric motor 7 and the position measuring device 10. The drive device 6 is preferably of a self-locking design so that the movable furniture part 5 is held practically in any heightwise position. The furniture flap 3 with the flap portions 3a and 3b is moved by way of the actuating arm 4. The downwardly movable furniture part 5 can be coupled in respect of motion to the furniture flap 3 (by electrical and/or mechanical means) so that, when the furniture flap 3 is opened or closed, the downwardly movable furniture part 5 also moves. More desirably however the movement of the downwardly movable furniture part 5 can be triggered separately by a push button switch (not shown). The downwardly movable furniture part 5 has compartment shelves 20a and 20b which are provided for supporting additional items to be accommodated therein. The compensation device 11 shown in FIG. 1 is influenced in respect of force by the different loading condition of the downwardly movable furniture part 5 so that the movable furniture part 5 is preferably always moved with the same acceleration or deceleration, independently of the loading condition.

FIG. 3 shows a typical installation situation of an article of furniture 1 according to the invention which is suitable in particular as a wall cabinet in kitchens. The furniture carcass 2 is mounted stationarily above a worktop 21 and the movable furniture part 5 is substantially completely accommodated in the furniture carcass 2 in a first limit position but if required can be moved downwardly into a lower second limit position. In that way possible items to be accommodated therein can be easily introduced thereinto or removed, whereupon the furniture part 5 is movable upwardly again into the space-saving first limit position.

FIG. 4 shows the article of furniture 1, wherein the movable furniture part 5 is in the uppermost limit position relative to the furniture carcass 2. Starting from that illustration, the two flap portions 3a and 3b are movable into a vertical position so that the flap portions 3a and 3b substantially completely close the cabinet compartment formed by the movable furniture part 5, in a vertical position.

FIG. 5a shows a perspective view of a possible configuration of a compensation device 11. The compensation device 11 includes a spring device 22 mounted movably about a pivot point M. The spring device 22 acts on an intermediate lever 23 mounted at the pivot point S, wherein the spring mounting 24 of the spring device 22 on the intermediate lever 23 is displaceable by way of the displacement device 16. Due to a change, caused thereby, in the spacing between the spring mounting 24 and the pivot point S of the intermediate lever 23, besides the altered spring biasing, that also gives modified lever relationships. Accordingly, the torque acting on the adjusting arm 13 (not shown here) can be selectively adjusted by the adjustment device 16 in accordance with the respective weight of the downwardly movable furniture part 5. The adjustment device 16 has an electric motor 16a, the displacement movement of which is controllable by the measuring device 17 (FIG. 1). The spring mounting 24 is movable along a spindle arranged on the intermediate lever 23, a worm gear 26 being arranged at the upper end of the spindle. The electric motor 16a includes a worm 25 which displaces the worm gear 26 whereby the spring mounting 24 of the spring device 22 can be set at a variable spacing relative to the pivot point S of the intermediate lever 23. Mounted on the intermediate lever 23 is a pressure roller 27 which can run along an adjusting contour 28a of a control cam 28 mounted at the pivot point P during the pivotal movement of the adjusting arm 13. The control cam 28 has a coupling member 29 which can be releasably connected to the adjusting arm 13, preferably by latching engagement. FIG. 5b shows a portion of the adjustment device 16 as a side view on an enlarged scale. A rotary movement of the electric motor 16a is converted by way of the worm 25 and the worm gear 26 into a rotary movement of the spindle, on which the spring mounting 24 is mounted. That permits displacement of the spring mounting 24 of the spring device 22 along the intermediate lever 23. Reference 31 (FIG. 5a) identifies in its entirety a transmission mechanism which converts a movement of the spring mounting 24 into a pivotal movement of the adjusting arm 13.

FIG. 6 shows a partly broken-away rear view of the article of furniture 1, showing the stationary furniture carcass 2 and the furniture part 5 which is downwardly movable relative thereto. The drive device 6 with the electric motor 7 moves the furniture part 5 in the form of a carcass, by way of a toothed belt 8a. It is also possible to clearly see the compensation device 11 which is mounted to the stationary furniture carcass 2 and the compensation force of which is adjustable by way of the further electric motor 16a. The downwardly movable furniture part 5 has an angled fitment member 15, against which the roller 14 mounted on the adjusting arm 13 comes to bear and thus relieves the load on the electric motor 7 of the drive device 6 in accordance with the respective weight of the furniture part 5.

FIG. 7 shows a side view of the article of furniture 1. A measuring device 17 is provided to detect the weight of the downwardly movable furniture part 5. The upper mounting member 18a is associated with the downwardly movable furniture part 5 while the lower mounting member 18b is mounted to the stationary furniture carcass 2. Reference 30 indicates by way of example a force measuring cell which detects the contact force of the mounting member 18a (that is to say the overall weight of the downwardly movable furniture part 5), whereupon a corresponding compensation force in opposite relationship to the force due to the weight is applied to the downwardly movable furniture part 5.

The present invention is not limited to the illustrated embodiment but includes or extends to all variants and technical equivalents which can fall within the scope of the claims appended hereto. The positional references adopted in the description such as for example up, down, lateral and so forth are also related to the usual position of installation and to the directly described and illustrated Figure and are to be appropriately transferred to the new position upon a change in position. It is to be noted that all components of the furniture drive according to the invention can also be arranged in a common unit, thereby giving a particularly compact unit.

1. A furniture drive for moving a furniture part which is mounted displaceably in respect of height, comprising a drive device with an electric motor for moving the movable furniture part and a compensation device which exerts on the movable furniture part a force opposite to the force due to weight, wherein there is provided a measuring device for detecting the weight of the movable furniture part so that the force exerted by the compensation device on the movable furniture part is variably adjustable in dependence on the measured weight of the movable furniture part by an adjustment device which has a further electric motor and which is actuable by the measuring device.

2. The furniture drive according to claim 1, wherein the measuring device for detecting the weight of the movable furniture part includes at least one force measuring cell, by which a force signal corresponding to the weight of the movable furniture part can be fed to the compensation device.

3. The furniture drive according to claim 1, wherein the compensation device has a spring device, wherein the biasing of the spring device is adjustable by the adjustment device.

4. The furniture drive according to claim 3, wherein the spring device has a spring mounting, wherein the position of the spring mounting is movable by the displacement device so that the biasing of the spring device is variable thereby.

5. The furniture drive according to claim 3, wherein the compensation device has an adjusting arm for moving the movable furniture part, wherein a transmission mechanism converts a movement of the spring device into a pivotal movement of the adjusting arm.

6. The furniture drive according to claim 5, wherein the adjusting arm has a roller (14) which rolls against the movable furniture part or a fitment member associated with the movable furniture part.

7. The furniture drive according to claim 2, wherein the drive device is operative on the movable furniture part by way of a transmission mechanism.

8. The furniture drive according to claim 7, wherein the transmission mechanism (8) includes at least one toothed belt.

9. The furniture drive according to claim 1, wherein the furniture drive has a position measuring device, by which a position signal characteristic of the opening condition of the movable furniture part can be produced.

10. An article of furniture having at least one furniture drive according to claim 1.

11. The article of furniture according to claim 10, wherein the article of furniture has a furniture carcass and at least one furniture part movable relative thereto, wherein the movable furniture part is movable by the furniture drive.

12. The article of furniture according to claim 11, wherein the movable furniture part is a carcass portion in cabinet form arranged at least region-wise within the furniture carcass.

13. The article of furniture according to claim 11, wherein the movable furniture part is pivotable and/or linearly movable relative to the furniture carcass.
